(19) United States
(12) Patent Application Publication
(10) Pub. No.: US 2026/0277384 A1
(43) Pub. Date: Sep. 17, 2026

(54) SYSTEM AND METHOD FOR VIRTUAL ENVIRONMENT AUTHORING AND STRUCTURED EXPORT OF PROCESS WORKFLOWS

(71) Applicant: NormIP LLC

(72) Inventor: Jorge Gabriel Normandia Urbina

(73) Assignee: NormIP LLC, (US)

(21) Appl. No.: 19/564,060

(22) Filed: Mar. 11, 2026

Related U.S. Application Data
(60) Provisional application No. 63/771,464, filed on Mar. 13, 2025.

(51) Int. Cl. G06F 3/04815; G06Q 10/0631

(52) U.S. Cl. CPC G06F 3/04815; G06Q 10/06316

(57) ABSTRACT

A computer‑implemented method and system that provides a virtual environment in which users visually define, navigate, and modify process workflows using workstation‑centric representations of a facility. Within the environment, users author hierarchical process content comprising stations, phases, and steps with associated logic, compliance information, and data‑collection requirements, which are stored in a structured, machine‑readable form. The system applies configurable sequencing modes, including linear, station‑based, and custom flows, to generate an ordered execution path and then exports the resulting workflows as structured data, such as JavaScript Object Notation (JSON), Comma‑Separated Values (CSV), or Extensible Markup Language (XML), suitable for downstream consumption by automated and artificial‑intelligence systems.

### CROSS-REFERENCETORELATEDAPPLICATIONS

This application claims the benefit of U.S. Provisional Application No. 63/771,464, filed Mar. 13, 2025, entitled "Enhanced System and Method for Visual Representation of Processes in Virtual Environments," the entire contents of which are incorporated herein by reference.

### STATEMENT REGARDING FEDERALLY SPONSORED RESEARCH AND DEVELOPMENT

Not Applicable.

### BACKGROUND

### Field of The Invention

The present disclosure relates to computer‑implemented systems and methods for visual representation and management of processes in virtual environments. It more particularly concerns techniques for authoring, navigating, sequencing, and exporting process workflows defined within multidimensional virtual environments, including environments accessible via desktop, laptop, or head‑mounted display platforms, into structured data formats suitable for downstream automated and artificial‑intelligence‑based processing.

### Existing Technologies and Challenges

Virtual environments have evolved from primarily entertainment and gaming contexts into tools used in process design, training, and operations across manufacturing, life sciences, logistics, and other complex industries. Existing workflow documentation practices—such as text‑based procedures, static diagrams, and manually maintained flowcharts—are often created and updated by hand, making them time‑consuming to maintain, difficult to validate against the physical layout, and prone to inconsistency and human error. As processes grow in complexity and regulatory scrutiny increases, there is a heightened need for systems that can provide an interactive, accurate, and maintainable representation of process workflows that remains aligned with the physical or logical environment in which those workflows are executed.

Multidimensional virtual environments, including immersive three‑dimensional environments, provide an engaging way to visualize and explore proposed workflows by allowing stakeholders to “walk” a process, observe station‑to‑station flow, and experiment with alternative arrangements. However, conventional virtual‑reality and 3D tools typically treat the experience as a visualization layer and do not maintain a robust, machine‑readable representation of the underlying process logic, data‑collection requirements, and execution sequence. As a result, information captured or validated in the virtual environment must often be re‑created manually in separate systems for documentation, analysis, or execution, which undermines consistency and limits the usefulness of the virtual modeling effort. There remains a need for systems that not only render and navigate virtual process representations, but also automatically capture the authored process as structured data and export it in standardized formats suitable for integration with documentation engines, manufacturing execution systems, and artificial‑intelligence platforms. The disclosed invention addresses these challenges by providing a multidimensional virtual environment tightly coupled to a structured process model, enabling interactive visual authoring and navigation of workflows together with automated generation of standardized, exportable representations of the process.

### SUMMARY

The disclosure provides a computer‑implemented system and method for visually defining, navigating, sequencing, and exporting process workflows within a virtual environment. In various embodiments, a visual representation system renders a depiction of a facility and associated workstations, allows users to interactively explore and modify a proposed process in a multidimensional virtual space, and maintains a hierarchical model of stations, phases, and steps linked to the visual elements. The system applies one or more sequencing modes, which may include linear, station‑based, or custom execution orders, to organize the authored process workflows into an ordered sequence suitable for review and downstream use.

The system further translates the ordered process workflows into machine‑readable data representations and exports them in one or more structured formats, such as JavaScript Object Notation (JSON), Comma‑Separated Values (CSV), or Extensible Markup Language (XML), and in some embodiments in additional unstructured or semi‑structured narrative forms. These exports may include project‑level metadata together with narrative blocks for each step, enabling compatibility with a wide range of external systems, including automated documentation tools, manufacturing execution systems, and artificial‑intelligence engines. A non‑transitory computer‑readable medium may store instructions that, when executed by a processor, cause the processor to implement the visual representation system, including rendering the virtual environment, enabling navigation and interaction, applying sequencing logic, and generating the structured data exports.

In certain embodiments, the virtual environment is immersive and multi‑user, allowing multiple participants to concurrently explore the visual depiction of the proposed process, review and validate the execution sequence, and collaboratively refine process definitions. The system’s ability to maintain a consistent mapping between visual elements and the underlying structured data, and to automatically convert the resulting process workflows into organized, standardized formats such as JSON, CSV, and XML, provides a comprehensive and flexible representation of the proposed process that supports both human understanding and automated downstream processing.

### BRIEF DESCRIPTION OF THE FIGURES

The accompanying drawings illustrate various embodiments and along with the description, help explain the principles of the method. It is understood by those skilled in the art that the specific arrangements shown in the drawings are merely examples and should not be considered as limiting the scope of the method or the claims in any way.

FIG. 1: A block diagram of a collaborative three‑dimensional process environment

FIG. 2: A functional block diagram of a visual authoring system

FIG. 3: A flow diagram of an in‑world process authoring method in which a user enters a three‑dimensional virtual environment

FIG. 4: A high‑level application workflow diagram illustrating desktop access to the platform

FIG. 5: A screenshot or schematic view of a virtual facility layout during an active multi‑user session

FIG. 6: An example of a structured manufacturing process description export

FIG. 7: A user interface flow diagram of a custom flow sequencer

FIG. 8: A workflow diagram summarizing four phases of operation

### DETAILED DESCRIPTION

### System Overview

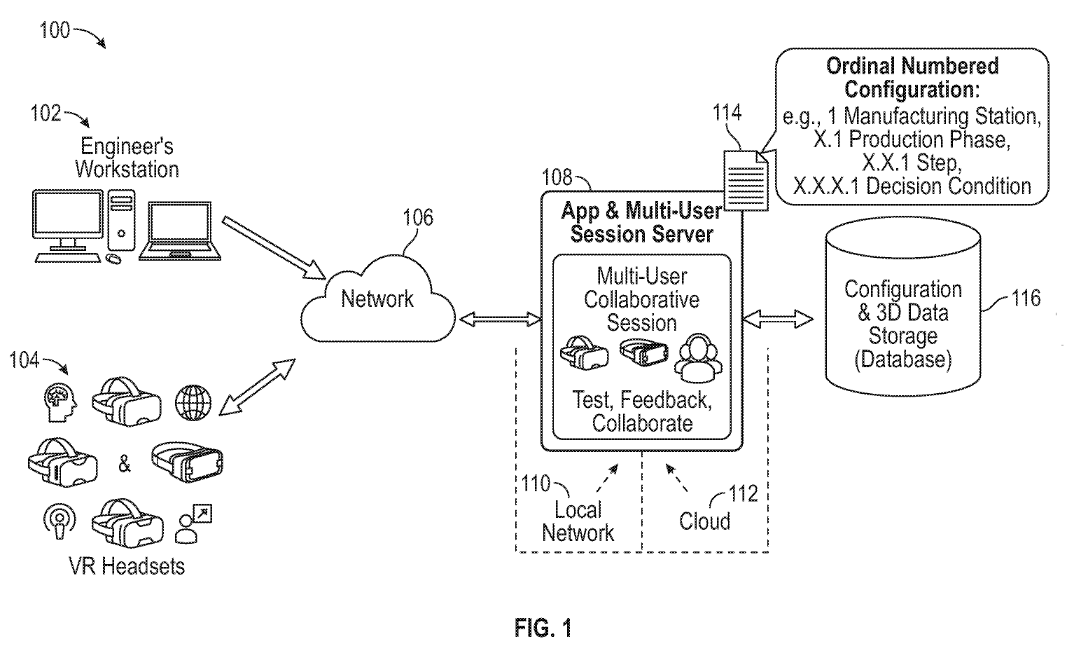

The disclosure provides a computer‑implemented system and method for visually authoring, sequencing, reviewing, and exporting structured process workflows within a multidimensional virtual environment. In one preferred embodiment, and as generally illustrated in FIGS. 1–4, the system includes one or more engineer’s workstations 100 that connect over a network 102 to an application and multi‑user session server 106 configured to host a multi‑user collaborative three‑dimensional environment 108. The environment 108 may be accessed via desktop or laptop clients 202 and, in some cases, via virtual‑reality headsets 104, allowing multiple users to simultaneously participate in test, feedback, and collaboration sessions. The session server 106 is coupled to a local network 110 and/or a cloud network 112 and manages collaborative sessions in which users may test proposed workflows, provide feedback, and iteratively refine process definitions, while configuration and three‑dimensional layout data are stored in one or more configuration and 3D data storage databases 116. In a preferred implementation, an ordinal numbered configuration 114 is applied across the environment so that each manufacturing station, production phase, executable step, and decision condition is associated with a unique hierarchical identifier (for example, “1” for a station, “X.1” for a phase, “X.X.1” for a step, and “X.X.X.1” for a decision condition), thereby providing stable keys for sequencing, traceability, and export. In alternative embodiments, the ordinal scheme may be extended or replaced with other hierarchical labeling systems (for example, alphanumeric or UUID‑based identifiers) while preserving a one‑to‑one mapping between visual elements and process nodes.

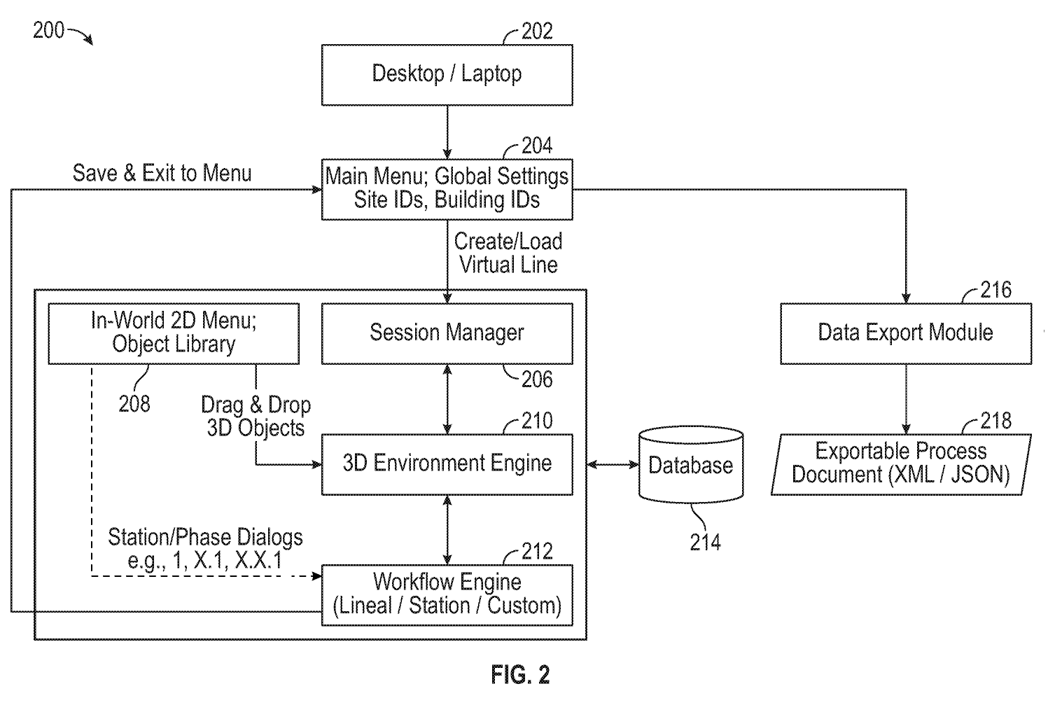

As depicted in FIG. 2, a desktop or laptop client 202 presents a main menu and global settings interface 204 that allows the user to configure project‑level parameters, such as site IDs, building IDs, and other global metadata, and to launch or join a multi‑user session. Within the three‑dimensional environment, an in‑world two‑dimensional menu overlays the scene and exposes an object library, a session manager 206, and station/phase dialogs that are keyed to the ordinal identifiers (for example, “1,” “X.1,” “X.X.1”). A three‑dimensional environment engine 210 renders the virtual facility and supports drag‑and‑drop placement and manipulation of three‑dimensional objects that represent workstations and equipment. A workflow engine 212 supports multiple sequencing modes, including lineal, station‑grouped, and custom flows, and a data export module 216 generates structured process documents 218, such as XML or JSON files, based on the authored and sequenced workflows. The system further provides save and exit functionality associated with the main menu 204 that returns the user to the menu interface while persisting configuration data to the database 214. In some preferred embodiments, the client 202 and server 106 communicate over secure channels and authenticate users before allowing access to collaborative sessions, while in other embodiments the system may operate in a single‑user, offline mode in which all processing and storage occur locally on the client.

### Spatial Modeling Phase

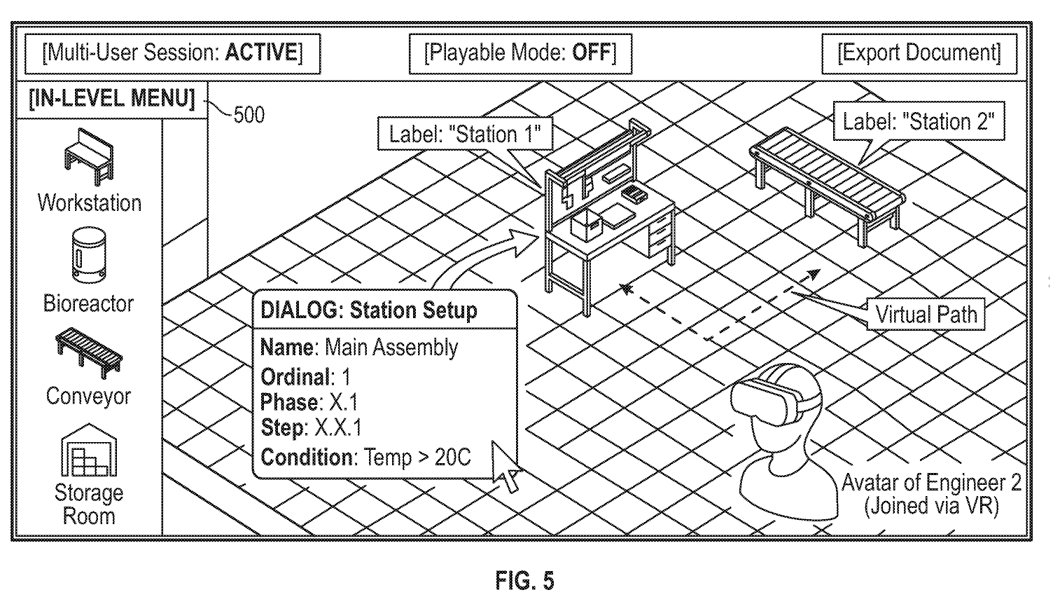

In a first phase of operation, referred to herein as a spatial modeling phase and illustrated in FIGS. 1, 3, 5, and 8, the system renders an interactive three‑dimensional virtual environment resembling a facility layout. In this environment, users drag, position, rotate, and scale workstation objects representing real‑world production, assembly, inspection, test, or storage locations, using the drag‑and‑drop 3D object capability 200 provided by the 3D environment engine 210. Each workstation object is assigned a unique ordinal identifier, such as “1,” “2,” “3,” and so forth, thereby establishing a default spatial or logical sequence and serving as a stable anchor for associating additional process elements. Users may also place other three‑dimensional objects, such as conveyors, bioreactors, and storage rooms, by selecting corresponding items from an in‑level menu (for example, the “Workstation,” “Bioreactor,” “Conveyor,” and “Storage Room” entries shown in FIG. 5). In preferred embodiments, the spatial modeling phase is performed collaboratively by multiple users connected via the multi‑user session server 108 so that changes to the layout are propagated in real time to all participants; in alternative embodiments, a single user may configure the facility and later share the saved configuration for review.

The user can select a given workstation object to open an associated station setup dialog, as shown in FIG. 5, where station metadata such as station name (for example, “Main Assembly”), ordinal number (for example, “1”), and associated phase and step identifiers (for example, Phase “X.1,” Step “X.X.1”) are entered. The dialog may further include initial conditional logic fields, such as a temperature condition (“Temp > 20C”), and optional descriptive text regarding equipment or station roles. The system maintains a mapping between these dialog entries and the corresponding three‑dimensional objects so that later editing, validation, and execution remain visually and logically synchronized. One or more virtual paths may be drawn between stations, as depicted in FIG. 5, to visually indicate material or process flow through the facility. In some embodiments, the system may automatically suggest virtual paths based on station ordinals or proximity, while in other embodiments paths are manually drawn or may be omitted entirely where physical routing is not relevant.

### Content and Compliance Authoring Phase

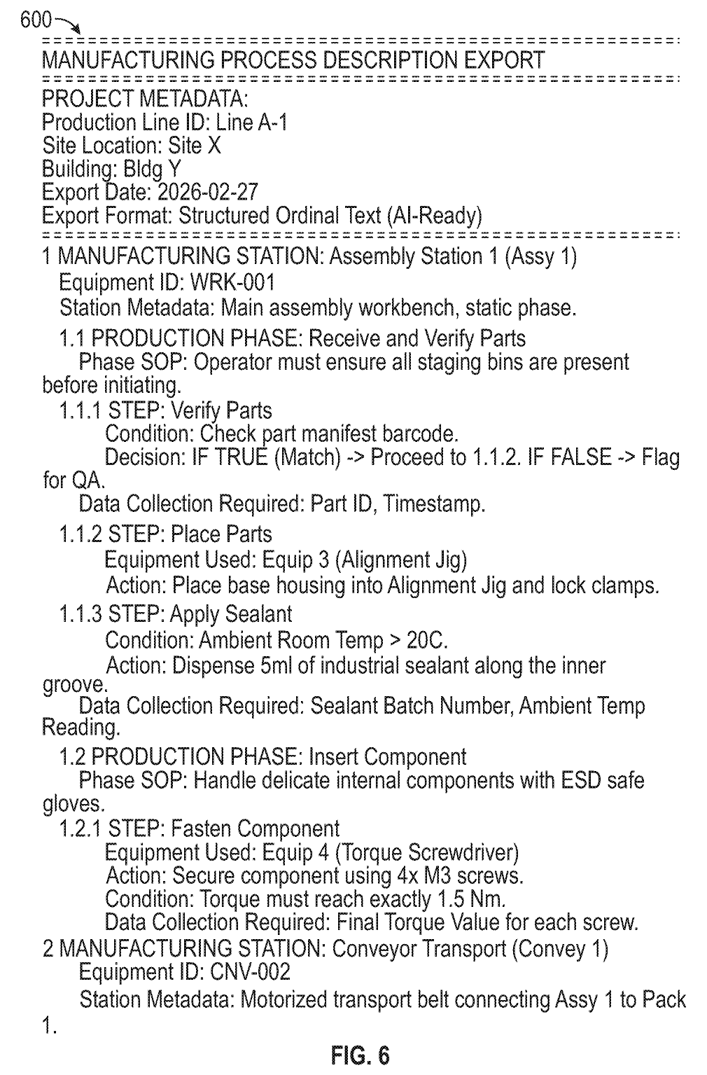

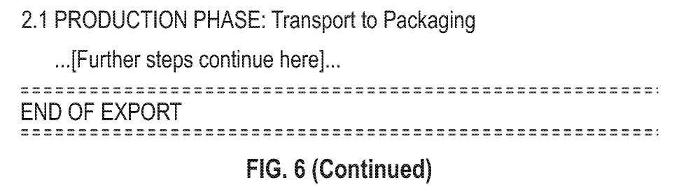

In a second phase, referred to as a content and compliance authoring phase and illustrated in FIGS. 2, 3, 5, 6, and 8, the system enables users to attach detailed process definitions and compliance information to the spatial model. Through in‑world dialog boxes (such as the station setup dialog of FIG. 5), overlaid two‑dimensional menus 206, or separate desktop forms, the user selects a workstation and defines one or more production phases associated with that workstation using the station/phase dialogs 212. For each phase, the user defines granular steps, each step having an associated ordinal identifier and one or more of the following: textual work instructions, safety notes, tooling and equipment prerequisites, pre‑conditions and post‑conditions, and other operational constraints. As illustrated by the manufacturing process description export 600 in FIG. 6, production phases (for example, “Receive and Verify Parts” and “Insert Component”) and their corresponding steps (for example, “Verify Parts,” “Place Parts,” “Apply Sealant,” and “Fasten Component”) may be documented with conditions, actions, and required equipment.

The system further allows the user to define structured data‑collection schemas at the phase or step level, including, for example, data field names, data types, validation rules, mandatory or optional flags, and traceability identifiers. Compliance annotations, such as references to regulatory standards, internal quality checkpoints, and risk assessments, may also be specified and stored in association with particular phases or steps. As process content is authored, the system records the resulting hierarchical definitions in the database 116 / 214 as structured records keyed by station, phase, step, and decision identifiers, thereby forming a machine‑readable representation of the process. An example of the type of structured text export that can be generated from such definitions is illustrated in FIG. 6, which shows an ordinally numbered manufacturing process description that includes project metadata (e.g., production line ID, site location, building, export date, and export format), station metadata (e.g., equipment IDs and station descriptions), phase‑level standard operating procedure notes, step‑level conditions and decisions (for example, barcode match checks and torque thresholds), and explicit data‑collection requirements (such as part IDs, timestamps, and measured values). In preferred embodiments, the authoring interfaces enforce validation rules defined in the data‑collection schemas to prevent incomplete or inconsistent process definitions; in alternative embodiments, validation may be deferred until export or performed by external quality systems.

### Logic Sequencing and Flow Definition Phase

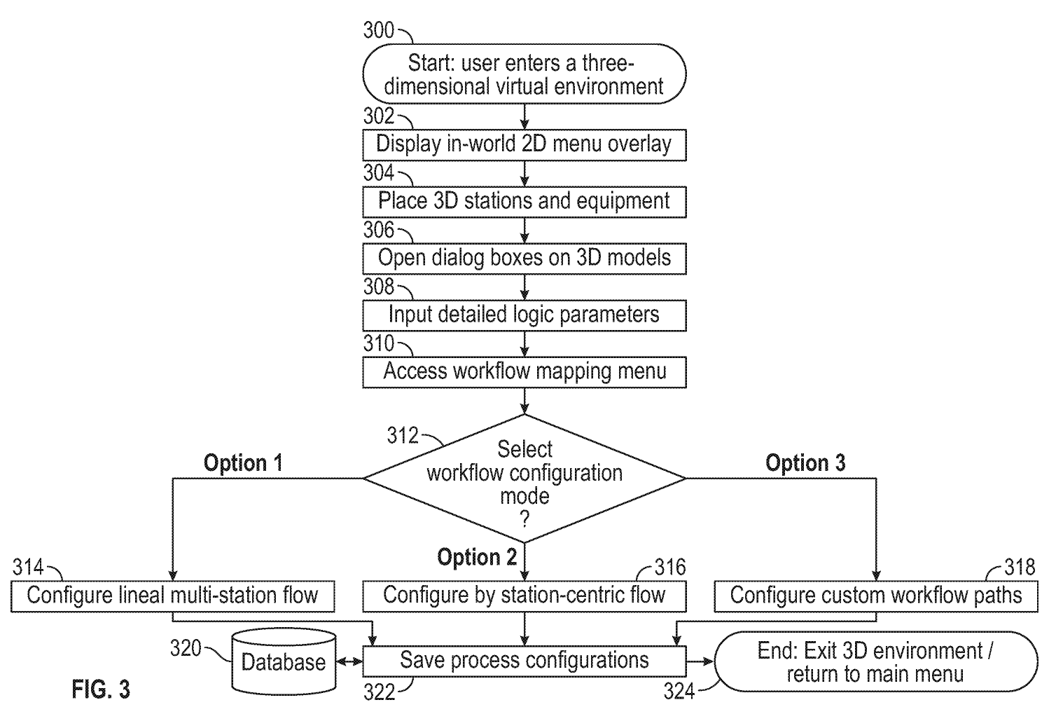

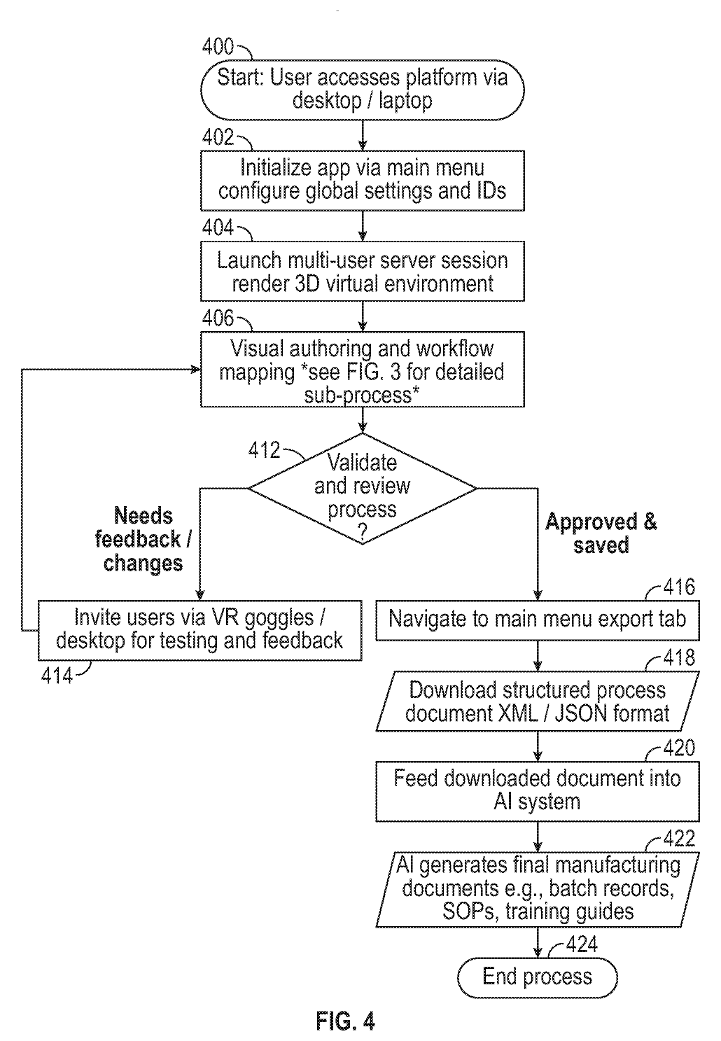

In a third phase, referred to as a logic sequencing and flow definition phase and illustrated in FIGS. 3, 7, and 8, the system transforms the authored process content into an executable sequence by applying one of multiple sequencing modes that are selectable by the user. In FIG. 3, after the user has placed stations and equipment at step 304, opened dialog boxes at step 306, and input detailed logic parameters at step 308, the user accesses a workflow mapping menu at step 310 and selects a workflow configuration mode at step 312. In a Linear Flow mode (option 1 at 314), the system automatically orders all process content globally by phase identifier and then by step identifier, producing a continuous, dependency‑driven sequence that is independent of physical workstation location. In a By‑Station Flow mode (option 2 at 316), the system groups and orders content first by workstation ordinal and then, within each workstation, by phase identifier and step identifier, thereby reflecting typical physical traversal patterns in line‑based or cellular manufacturing layouts.

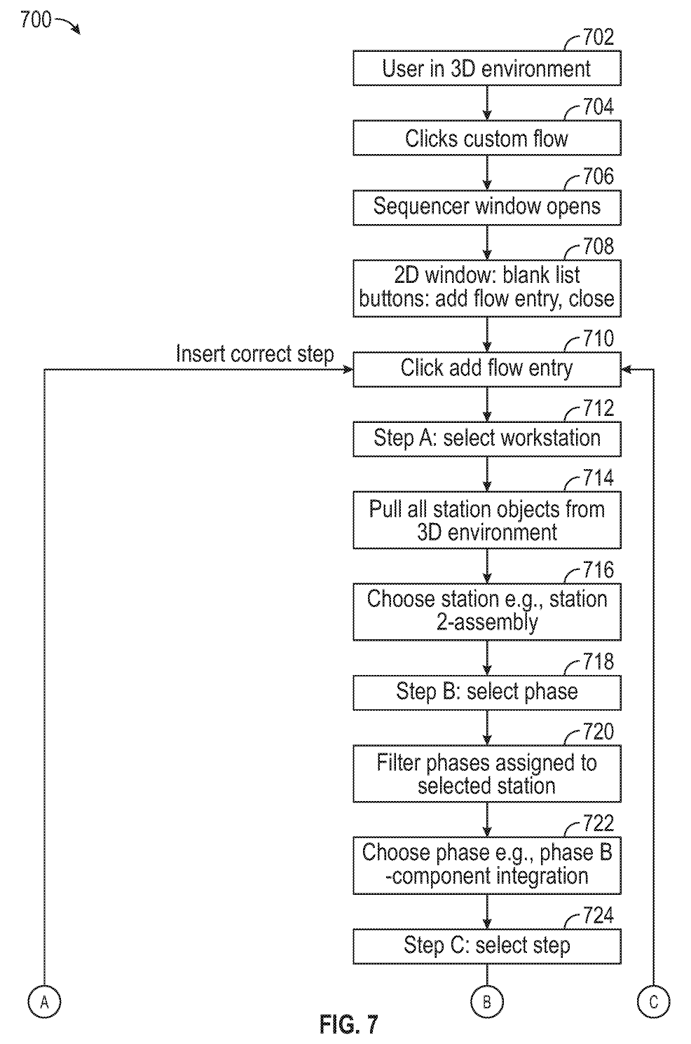

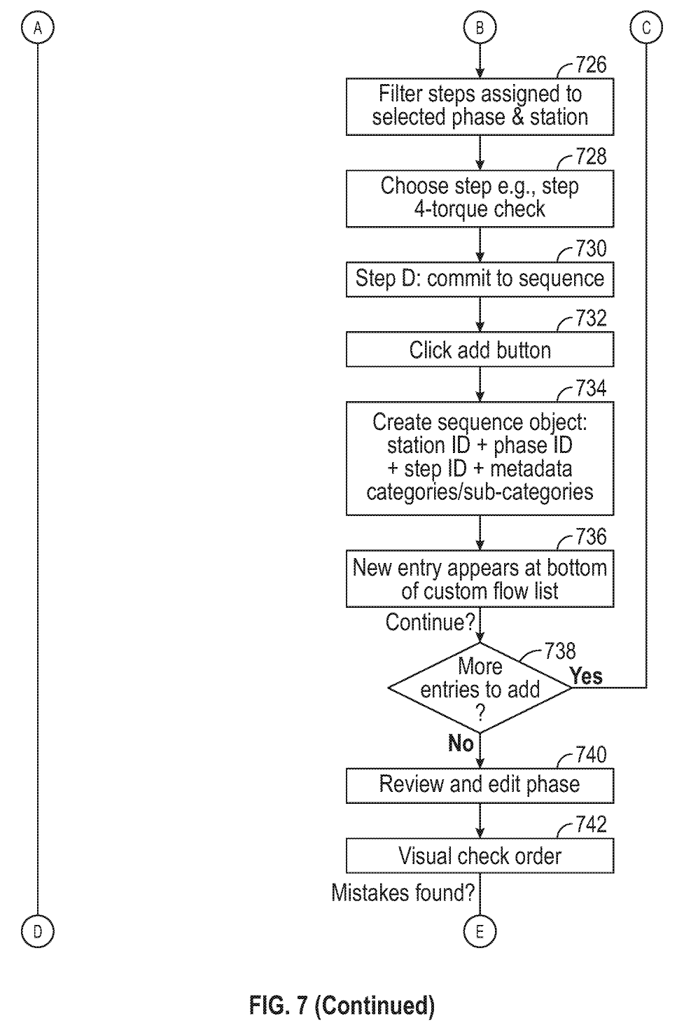

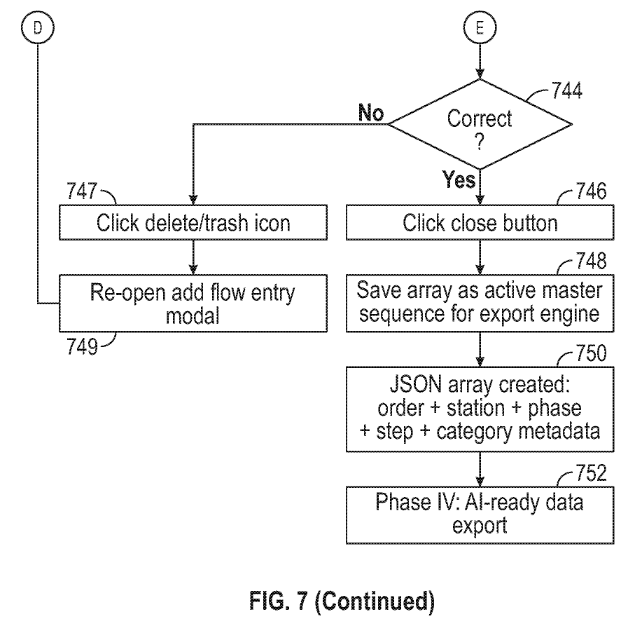

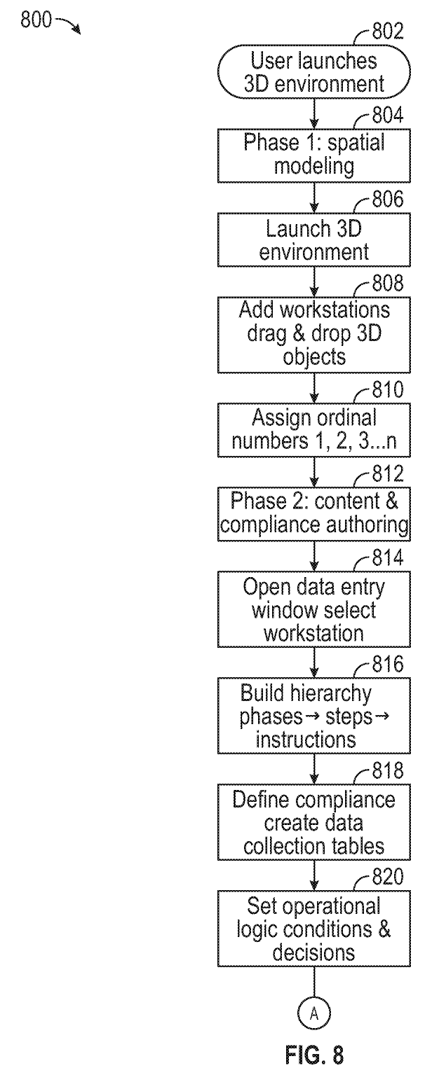

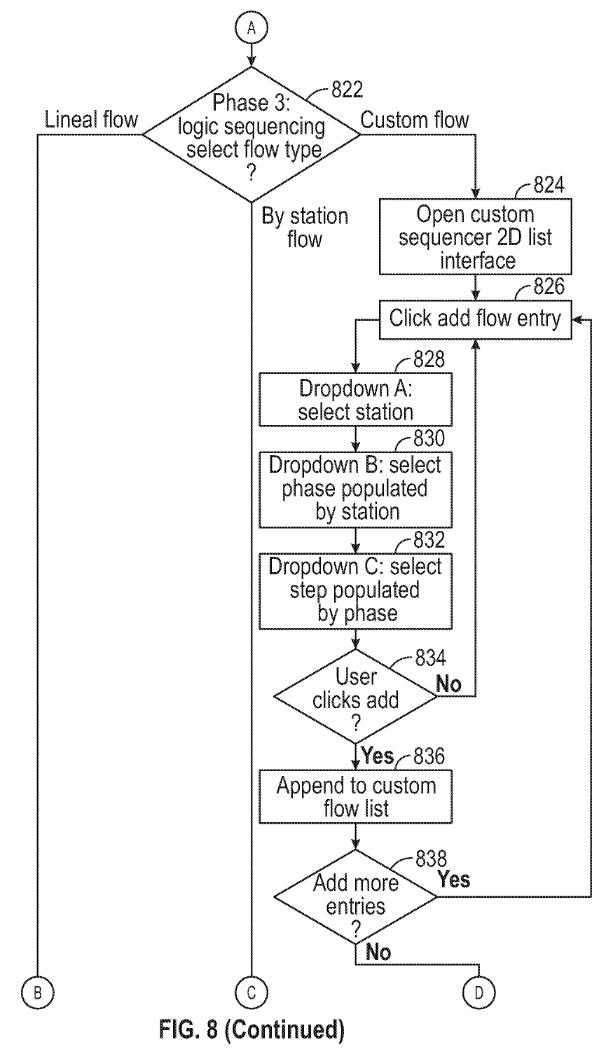

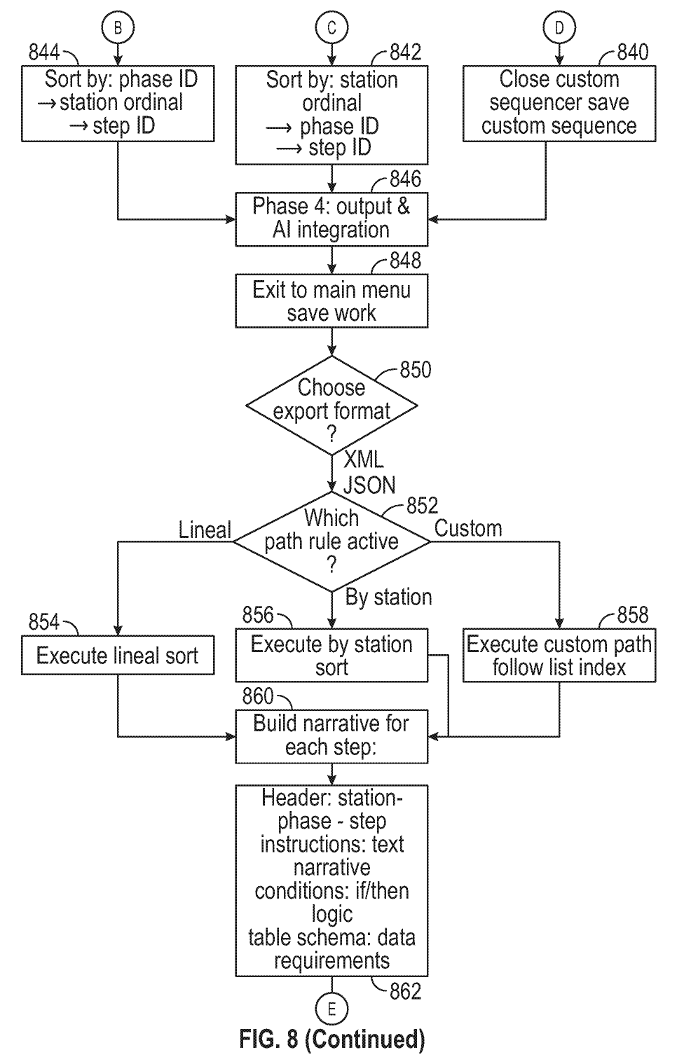

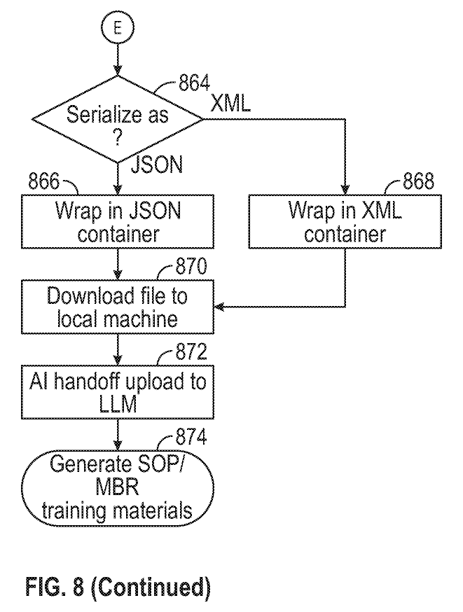

In a Custom Flow mode (option 3 at 318), the system presents a dedicated two‑dimensional sequencer interface that displays an ordered list of sequence entries. As shown in FIG. 7 and in the Phase 3 portion of FIG. 8 (822–838), a user in the three‑dimensional environment 702 may click a “custom flow” control 704, causing a sequencer window to open at 706 with a two‑dimensional list 708 and controls such as an “add flow entry” button 710 and a close button. Upon selecting the add control 710, a modal dialog with cascaded, context‑aware selectors is presented. In a first selector (Dropdown A at 714), the user selects a workstation from those present in the three‑dimensional model, which are pulled from the environment at 716. In a second selector (Dropdown B at 720), the system presents only phases that have been assigned to the selected workstation, filtered at 718, and the user selects one of those phases. In a third selector (Dropdown C at 724), the system presents only steps that belong to the selected phase at the selected workstation, filtered at 722, and the user selects a desired step.

For each confirmed selection, the system creates a structured sequence object at 734 containing at least a station identifier, phase identifier, and step identifier, and, in some embodiments, associated metadata categories and sub‑categories, conditional‑logic references, and data‑schema references, and appends that sequence object to the bottom of the ordered list at 736. The user may repeat this process to construct an arbitrary execution order that intentionally overrides the default linear or station‑centric ordering to accommodate tooling availability, material‑flow optimization, mixed‑product requirements, ergonomic constraints, or compliance dependencies. The sequencer interface supports visual review of the ordered list at 742 and, in some implementations, user interactions such as drag‑to‑reorder, deletion of entries via a delete or trash icon 747, and correction of entries by reopening the add‑entry modal at 749. Decision points 738 and 744 allow the user to determine whether mistakes have been found or additional entries should be added. When the user indicates that the custom sequence is correct at 7460, the ordered array is saved as an active master sequence for an export engine at 752 and may be stored in the database 116 / 214 as a JSON array that encodes order, station, phase, step, and category metadata. In preferred embodiments, the custom sequence becomes the governing path rule for subsequent export and for any simulation or playback of the process within the virtual environment; in alternative embodiments, multiple custom sequences may be stored and selected at export time.

### Output Generation and AI Handoff Phase

In a fourth phase, referred to as an output generation and AI handoff phase and illustrated in FIGS. 4, 6, and 8, the system generates a structured, machine‑readable representation of the process that is optimized for consumption by downstream systems, including artificial‑intelligence engines. As shown in FIG. 4, a user may access the platform via a desktop or laptop client at 400, initialize the application via the main menu at 402, launch a multi‑user server session at 404, and render the three‑dimensional virtual environment at 404 for visual authoring and workflow mapping at 406. After validation and review at 412, the user navigates to an export tab at 416 and downloads a structured process document at 418, for example in XML or JSON format. In FIG. 8, Phase 4 (840–862) further illustrates that, when the user selects an export command, the system determines which path rule is active (Lineal, By Station, or Custom) at 852 and applies the corresponding sequencing algorithm, such as sorting by station ordinal, phase ID, and step ID for a station‑based flow or following the index order of the custom sequence for a custom path.

For each step position in the resulting ordered sequence, the system constructs a narrative block at 860 by aggregating data from the underlying records associated with the corresponding station, phase, step, and decision nodes. This narrative block may include a standardized header specifying the station name and ordinal, the phase name and identifier, and the step name and identifier (for example, in the ordinal format shown in FIG. 6), followed by detailed textual instructions, conditional‑logic expressions (such as if/then branching), associated decision paths, data‑collection schema definitions (for example, field labels and constraints), compliance and safety annotations, and references to equipment or resources. The ordered collection of narrative blocks is serialized as JSON or XML at 864–872 and wrapped in a container object that carries global project metadata, including but not limited to facility identifier, line identifier, site and building identifiers, version information, export timestamp, authoring user, and active sequencing mode.

The system then makes the serialized file available for download to a local machine, storage in a connected database, or transmission via an application programming interface to one or more external systems, as suggested in FIGS. 4 and 8. In one embodiment, the exported file is provided to a large language model or other generative artificial‑intelligence engine, which uses the structured, ordinal narrative to automatically generate standardized operating procedures, master batch records, routed work instructions, multilingual documentation, interactive augmented‑reality guidance scripts, compliance reports, operator training materials, natural‑language narrations, or digital‑twin simulation inputs. The feedback and approval loop in FIG. 4 allows human reviewers to approve and save the generated outputs as “Approved & saved” or to request further changes where “Needs feedback/changes,” thereby closing the cycle between immersive authoring, collaborative review, and AI‑assisted documentation. In alternative embodiments, the AI handoff may target non‑LLM analytic engines, manufacturing execution systems, or training simulation platforms that consume the same structured export.

1. A computer-implemented method for visually representing a process, comprising:
rendering, in a virtual environment, a visual representation of a facility comprising a plurality of workstation objects;
receiving, via one or more user interfaces associated with the workstation objects, definitions of process workflows comprising production phases and steps associated with the workstation objects;
enabling user navigation and interaction within the virtual environment with the workstation objects and the process workflows; and
exporting the process workflows as structured data according to an ordered sequence.

2. The method of claim 1, wherein the virtual environment is a three-dimensional, multi-user environment accessible from at least one of a desktop or laptop client and a head-mounted display.

3. The method of claim 1, further comprising assigning hierarchical identifiers to elements of the process workflows, the hierarchical identifiers comprising at least a workstation identifier, a phase identifier, and a step identifier.

4. The method of claim 3, wherein assigning hierarchical identifiers comprises assigning: a first-level identifier to each workstation, a second-level identifier to each phase associated with a workstation, and a third-level identifier to each step associated with a phase.

5. The method of claim 1, wherein the structured data comprises a plurality of entries, and exporting the process workflows comprises generating, for each entry, a narrative block that includes a header identifying the workstation, phase, and step, and a body including at least one of instructions, conditions, and data-collection fields.

6. The method of claim 1, further comprising:
receiving a selection of one of a plurality of sequencing modes comprising at least a linear mode and a station-based mode; and
determining the ordered sequence based at least in part on the selected sequencing mode.

7. The method of claim 6, wherein:
the linear mode orders the process workflows based at least on phase identifiers and step identifiers independent of workstation; and
the station-based mode orders the process workflows based at least on workstation identifiers and phase identifiers.

8. The method of claim 1, further comprising:
presenting, in the virtual environment, a sequencer interface comprising a list of sequence entries and an add-entry control;
responsive to activation of the add-entry control, receiving a selection of a workstation, a phase associated with the workstation, and a step associated with the phase; and
adding a sequence entry corresponding to the selection to the ordered sequence.

9. The method of claim 8, further comprising allowing a user to modify the ordered sequence in the sequencer interface by at least one of deleting sequence entries and changing positions of sequence entries.

10. The method of claim 1, wherein exporting the process workflows as structured data comprises serializing the ordered sequence into at least one of JavaScript Object Notation (JSON), Comma-Separated Values (CSV), and Extensible Markup Language (XML), and including project-level metadata with the serialized data.

11. The method of claim 1, further comprising providing the structured data to an automated system configured to generate process documentation based on the structured data.

12. A system for visually representing a process, comprising:
at least one processor;
a memory storing instructions; and
one or more client devices coupled to the processor;
wherein the instructions, when executed by the processor, cause the system to:
render, to the one or more client devices, a virtual environment comprising a visual representation of a facility with a plurality of workstation objects;
receive, via user interfaces associated with the workstation objects, definitions of production phases and steps associated with the workstation objects;
enable user navigation and interaction with the workstation objects and the phases and steps within the virtual environment; and
export the phases and steps as structured data according to an ordered sequence.

13. The system of claim 12, wherein the virtual environment is a three-dimensional multi-user environment hosted by a session server and accessible from at least one of a desktop or laptop computer and a head-mounted display.

14. The system of claim 12, wherein the memory further stores data associating hierarchical identifiers with the workstation objects, the phases, and the steps, and a database configured to store the definitions keyed by the hierarchical identifiers.

15. The system of claim 12, wherein the instructions further cause the system to provide an authoring interface configured to receive, for each step, at least one of textual instructions, conditional-logic expressions, and data-collection schema information.

16. The system of claim 12, wherein the instructions further cause the system to implement a workflow engine configured to determine the ordered sequence based on a selected sequencing mode comprising at least a linear mode and a station-based mode.

17. The system of claim 12, wherein the instructions further cause the system to:
present a sequencer interface comprising a sequence list and an add-entry control;
responsive to the add-entry control, receive a selection of a workstation, a phase, and a step; and
add a corresponding sequence entry to the sequence list for use in determining the ordered sequence.

18. The system of claim 17, wherein the instructions further cause the system to allow editing of the sequence list by at least one of deleting entries and changing positions of entries.

19. The system of claim 12, wherein the instructions further cause the system to serialize the ordered sequence and associated information into at least one of JavaScript Object Notation (JSON), Comma-Separated Values (CSV), and Extensible Markup Language (XML).

20. The system of claim 19, wherein the instructions further cause the system to output the serialized data in a format configured for consumption by an artificial-intelligence system that generates process documentation based on the serialized data.
